(19) United States
(12) Patent Application Publication
(10) Pub. No.: US 2021/0279505 A1
(43) Pub. Date: Sep. 9, 2021

(54) PROGRESSIVE VERIFICATION SYSTEM AND METHODS

(71) Applicant: Shenzhen Malong Technologies Co., Ltd., Shenzhen (CN)

(72) Inventors: Yujie ZHONG, Shenzhen (CN); Zelu DENG, Shenzhen (CN); Weilin HUANG, Shenzhen (CN); Matthew Robert SCOTT, Shenzhen (CN)

(21) Appl. No.: 16/813,704

(22) Filed: Mar. 9, 2020

(51) Int. Cl. G06K 9/62; G06N 3/04; G06N 3/08; G06Q 20/20

(52) U.S. Cl. CPC G06K 9/6215; G06N 3/0454; G06K 9/6232; G06Q 20/208; G06K 9/6256; G06N 3/08

(57) ABSTRACT

This disclosure includes technologies for automated verification via digital image transformation or analysis in several progressive stages, which may include a stage of retrieval-model-based mismatch detection, a stage of cross-class mismatch detection, or a stage of inner-class mismatch detection. Further, the disclosed system is designed to progressively execute the verification process from a generality-attentive manner to a specificity-attentive manner. Finally, the disclosed system is designed to launch appropriate responses based on the verification outcome.

### BACKGROUND

Barcodes, affixed to many commercial products in the modern economy, have made automated checkout and inventory tracking possible in many retail sectors. A barcode, seemingly a trivial piece of label, can encode optical, machine-readable data. The universal product code (UPC) is a barcode symbology, mainly used for scanning of trade items at the point of sale (POS). Barcodes, particularly UPC barcodes, have shaped the modern economy, not only universally used in automated checkout systems but used for many other tasks, referred to as automatic identification and data capture.

There are some challenges associated with conventional identification or data capture processes. First, mislabeling would inevitably lead to misidentification. Second, labeling each product could be expensive, impractical, or error-prone on many occasions, such as for products sold in greengrocers, farmers' markets, or supermarkets. For unlabeled products, conventional systems may try to alphabetically or categorically enumerate every possible product in stock to assist users in selecting a correct product, which is like looking for a needle in a haystack sometimes. Browsing and comparing a long list of products require intense attention, which may lead to user frustration and errors. Further, conventional systems are prone to fraud. For example, scammers may intentionally switch the labels of certain items with those of cheaper products to pay less to merchants.

A technical solution is needed for automated verification via objective measures in identification or data capture processes for both labeled or unlabeled products.

### SUMMARY

This Summary is provided to introduce selected concepts that are further described below in the Detailed Description. This Summary is not intended to identify key features or essential features of the claimed subject matter, nor is it intended to be used as an aid in determining the scope of the claimed subject matter.

In general, aspects of this disclosure include a technical application for automated verification via digital image transformation or analysis in several progressive stages, which may include a stage of retrieval-model-based mismatch detection, a stage of cross-class mismatch detection, or a stage of inner-class mismatch detection. In various embodiments, various machine learning models and different internal processes may be invoked progressively in different stages of mismatch detection. Accordingly, the disclosed system is configured to progressively stage the verification process from a generality-attentive manner to a specificity-attentive manner. Further, the disclosed system is configured to launch appropriate responses based on the verification outcome.

In various aspects, systems, methods, and computer-readable storage devices are provided to improve a computing system's ability for image-based verification in general. Specifically, one aspect of the technologies described herein is to improve the efficiency of a computing system's ability to perform verification tasks, including generating a verification code in an earlier stage based on a progressive verification process. Another aspect of the technologies described herein is to improve a computing system's ability to model representative features of a pair of images in different granularities, e.g., from a generality-attentive level to a specificity-attentive level to increase their mutual-differentiation power. Yet another aspect of the technologies described herein is to improve a computing system's ability to perform various functions or other practical applications in response to the verification outcomes, as discussed in the DETAILED DESCRIPTION.

### BRIEF DESCRIPTION OF THE DRAWINGS

The technologies described herein are illustrated by way of example and not limited in the accompanying figures in which like reference numerals indicate similar elements and in which:

FIG. 1 is a schematic representation illustrating an exemplary operating environment and a block diagram of an exemplary verification system, in accordance with at least one aspect of the technologies described herein;

FIG. 2 is a schematic representation illustrating an exemplary verification process, in accordance with at least one aspect of the technologies described herein;

FIG. 3 is a schematic representation illustrating an exemplary process with an exemplary retriever, in accordance with at least one aspect of the technologies described herein;

FIG. 4 is a schematic representation illustrating an exemplary process with an exemplary CCMD, in accordance with at least one aspect of the technologies described herein;

FIG. 5 is a schematic representation illustrating an exemplary process with an exemplary ICMD, in accordance with at least one aspect of the technologies described herein;

FIG. 6 is a schematic representation illustrating an exemplary process with an exemplary attention network, in accordance with at least one aspect of the technologies described herein;

FIG. 7 is a flow diagram illustrating an exemplary process of verification, in accordance with at least one aspect of the technologies described herein;

FIG. 8 is a flow diagram illustrating another exemplary process of verification, in accordance with at least one aspect of the technologies described herein; and

FIG. 9 is a block diagram of an exemplary computing environment suitable for use in implementing various aspects of the technologies described herein.

### DETAILED DESCRIPTION

The various technologies described herein are set forth with sufficient specificity to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” or “block” may be used herein to connote different elements of methods employed, the terms should not be interpreted as implying any particular order among or between various steps herein disclosed unless and except when the order of individual steps is explicitly described. Further, the term “based on” generally denotes that the succedent condition is used in performing the precedent action.

In the modern economy, many products are affixed with machine-readable labels (MRLs), such as UPC barcodes, QR codes, RFID tags, etc. MRLs may be provisioned by a manufacturer, e.g., a UPC label on a TV; or by a retailer, e.g., a UPC label for an apple in a supermarket. MRLs may be read by scanning devices for automatic identification and data capture, e.g., supporting transactions at point of sale (POS) locations, tracking inventory at warehouses, facilitating transportation of goods in commerce, etc.

MRL-based technologies have made self-checkout and cashier-less retail increasingly popular for the new retail industry. Self-checkout, also known as self-service checkout, is an alternative to the traditional cashier-staffed checkout, where self-checkout machines are provided for customers to process their purchases from a retailer. On the other hand, a cashier-less retail store may be partially or fully automated to enable customers to purchase products without being checked out by a cashier and without using self-checkout machines.

However, these new retail modalities, self-checkout or cashier-less, are generally more vulnerable, compared to traditional cashier-staffed checkout, for product misidentification. Product misidentification usually leads to shrinkage, a form of preventable loss for retailers caused by deliberate or inadvertent human actions. Sometimes, MRLs may be accidentally misplaced and affixed to unintended products. Mislabeling would inevitably lead to misidentification. Further, labeling each product could be expensive, impractical, or error-prone on many occasions, such as for products sold in greengrocers, farmers' markets, or supermarkets. Moreover, for unlabeled products, conventional systems may try to alphabetically or categorically enumerate every possible product in stock to assist users in selecting a correct product, which is like looking for a needle in a haystack sometimes. Browsing and comparing a long list of products require intense attention, which may lead to user frustration and errors. Additionally, conventional systems are prone to fraud. For example, scammers may intentionally switch the labels of certain items with those of cheaper products to pay less to merchants. Typically, a lower-priced MRL is fraudulently affixed to a higher-priced product, so the higher-priced item could be purchased for less.

A technical solution is provided in this disclosure for automated verification via objective measures in identification or data capture processes for both labeled or unlabeled objects. As used herein, verification refers to the process or the outcome of matching a physical object (e.g., an animal, a product or portion thereof, or set thereof) with a corresponding object type in a hierarchical structure. Further, inner class mismatch detection (ICMD) refers to a verification associated with object types in the same class. Conversely, cross-class mismatch detection (CCMD) refers to a verification associate with object types in different classes.

In various embodiments, as the hierarchical structure changes based on the specific practical application, the respective scopes of ICMD and CCMD may change as well. By way of example, under one type of hierarchy for animals, a verification between Lion and Tiger may be considered as cross-class mismatch detection. However, a verification between Lion and Leopard may be considered as inner class mismatch detection. Similarly, on the one type of hierarchy for fruits, a verification between Apple and Banana may be considered as cross-class mismatch detection. Another verification between Fuji Apple and Gala Apple may be considered as inner class mismatch detection.

In some embodiments, in a retail environment, the product hierarchy may be automatically established based on the visual similarities among products, which can be learned with machine learning models. Accordingly, ICMD may be used to verify two highly similar products, while CCMD may be used to verify two less similar products.

At a high level, to improve conventional systems, the disclosed technologies are designed for verification via digital image transformation or analysis in several progressive stages, which may include a stage of retrieval model mismatch detection (RMMD), a stage of CCMD, or a stage of ICMD. In various embodiments, various machine learning models and different internal processes may be invoked progressively in different stages of verification. Accordingly, the disclosed system is configured to progressively stage the verification process from a generality-attentive manner to a specificity-attentive manner. The details will be further discussed in connection with various figures.

The disclosed technologies provide many improvements over conventional technologies. Specifically, one aspect of the technologies described herein is to enable a computing system to perform a verification task automatically so users no longer need to manually conduct the verification task. For example, a conventional checkout machine may lack any effective means to verify whether a product being sold matches the listed product in the transaction. After implanting the disclosed technologies, an improved checkout machine now can automatically accomplish the verification task.

Another aspect of the technologies described herein is to improve a computing system's ability to model representative features of a pair of images in different granularities, e.g., from less granular to more granular, to increase their mutual-differentiation power. Accordingly, progressive verification stages may be designed to compare two images in different granularities, e.g., from a generality-attentive level to a specificity-attentive level.

Yet another aspect of the technologies described herein is to improve the efficiency of a computing system's ability to perform verification tasks, including generating a verification code in an earlier stage based on a progressive verification process. For example, if a positive verification code is obtained at the RMMD stage, the verification process can quickly stop without going through the rest of the verification stages. Similarly, other early exit points are designed in the verification process to complete the verification task without running through all progressive stages. In this way, this improved computing system may execute verification tasks based on their respective inherited complexities. A complex verification task may be executed in a slower specificity-attentive manner. However, a simple verification task may be executed in a faster generality-attentive manner. As not all verification tasks need to run through all progressive stages, the overall computing efficacy is improved and the computing resources are saved. To users, this improved computing system may appear as very fast with quick responses.

Yet another aspect of the technologies described herein is to improve a computing system's ability to perform various functions or other practical applications in response to the verification outcomes. By way of example, when a negative verification outcome is detected, the disclosed system may send a warning message, including one or more images or video segments relevant to the objects being verified, to a designated device to warn a human operator so the human operator may take appropriate loss-prevention actions or otherwise correct the issue.

As discussed previously, the disclosed technologies provide a general and flexible framework for machine learning-based verification. Accordingly, the disclosed technologies may be used in various practical systems, such as loss prevention systems in a retailer, quality control systems in a manufacturer, or other kinds of verification tasks in other practical systems or applications.

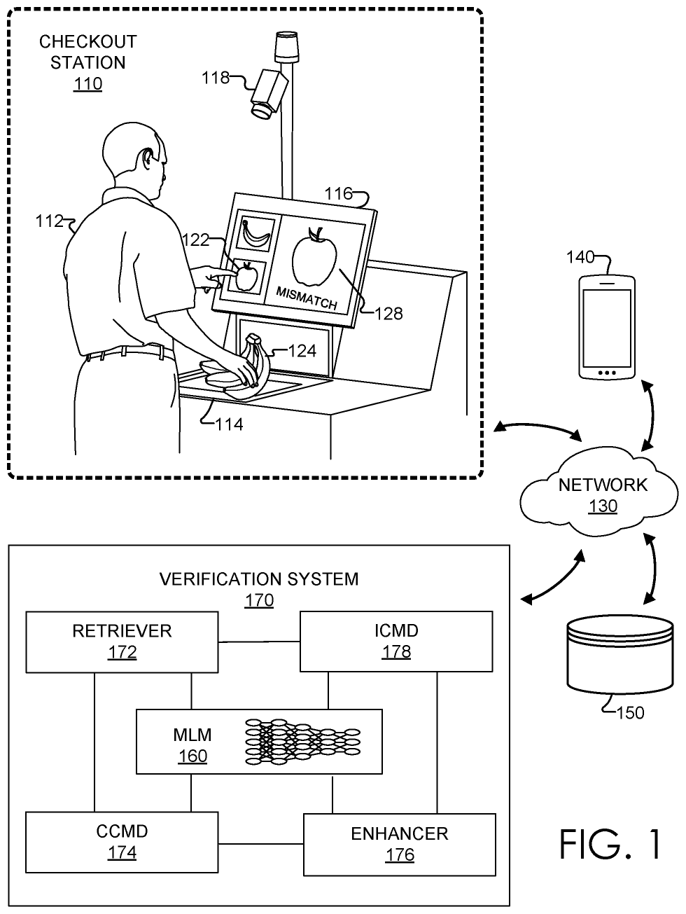

Having briefly described an overview of aspects of the technologies described herein, referring now to FIG. 1, which is a schematic representation illustrating an exemplary operating environment, specifically with checkout station 110, and a block diagram of an exemplary verification system 170. In this operating environment, checkout station 110 includes, among many components not shown, scanner 114, display 116, and camera 118. This checkout system may be used by user 112 for self-checkout or to help others checkout goods.

In some embodiments, verification system 170 is installed in checkout station 110. In some embodiments, verification system 170 is operatively coupled to checkout station 110, e.g., via network 130, which may include, without limitation, a local area network (LAN) or a wide area network (WAN), e.g., a 4G or 5G cellular network. This checkout station 110 is merely one example of a suitable computing environment for verification system 170 and is not intended to suggest any limitation as to the scope of use or functionality of aspects of the technology described herein. Additionally, this operating environment should not be interpreted as having any dependency or requirement relating to any one component nor any combination of components illustrated.

Enabled by verification system 170, checkout station 110 is adapted to automatically verify whether the product being checked out, e.g., product 124, matches the corresponding product type in the transaction. For instance, product 124 includes a bunch of bananas, and user 112 selects image 122 for checkout during this transaction. Verification system 170 will detect a mismatch between the physical object (i.e., bananas) and the product class being selected for checkout (i.e., class of apple). Further, verification system 170 is configured to cause message 128 to be displayed on display 116 to indicate this detected mismatch.

At a high level, verification system 170 is configured to verify whether two images belong to the same class. In some embodiments, it means to verify whether an image shares known features of a particular class of images. In one example, user 112 is using checkout station 110 to select the image class represented by image 122, which may be retrieved by verification system 170 from data storage 150. Meanwhile, camera 118 will capture an image of product 124. The features of this newly captured image may be learned by verification system 170 on demand, progressively in some embodiments, from retriever 172 to CCMD 174, then to ICMD 178. Further, enhancer 176 may be used by CCMD 174 or ICMD 178 to enhance the discriminative features of this newly captured image, such that the enhanced features may be compared to the known features of the image class represented by image 122.

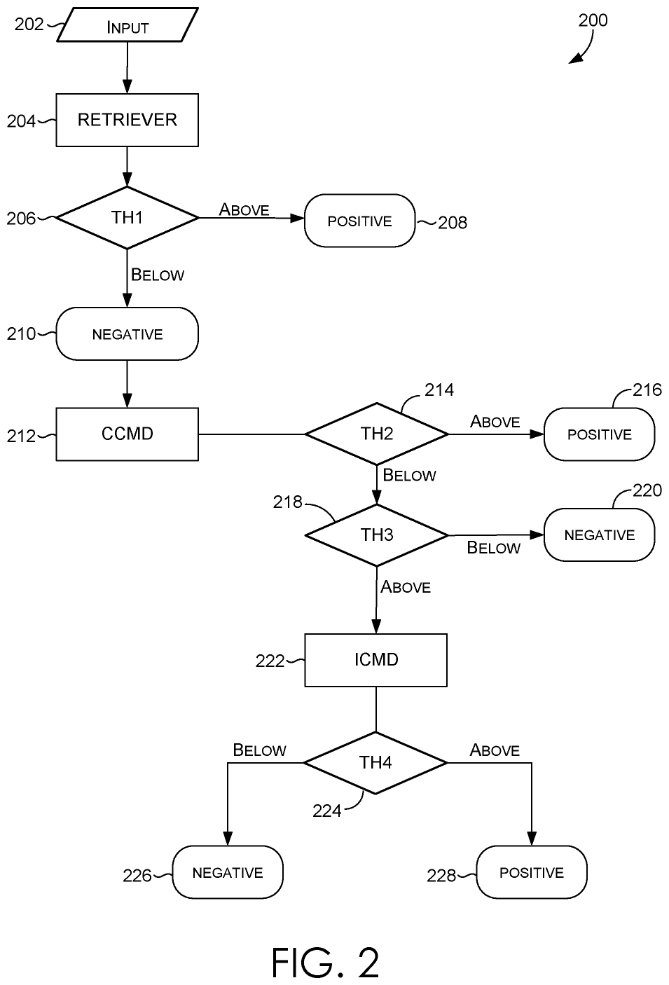

Verification system 170 may output positive or negative verification code(s) in various progressive stages. A positive verification code indicates the features of this newly captured image match the features of the image class represented by image 122. A negative verification code indicates the features of this newly captured image do not match the features of the image class represented by image 122. Various thresholds are used in different verification stages for generating either positive or negative verification code(s), which will be further discussed in connection with FIG. 2.

Subsequently, verification system 170 may cause the verification code or a message reflecting the verification code to display, e.g., via graphical user interface (GUI), on checkout station 110, alternatively on a computing device 140, e.g., a smartphone, a mobile device, or a computer. Advantageously, user 112, after seeing message 128 on display 116, may remedy the mismatch issue, e.g., by selecting another image from the GUI. Alternatively, a customer service representative, after an alert message being sent to computing device 140, may be summoned to resolve issues related to the mismatch.

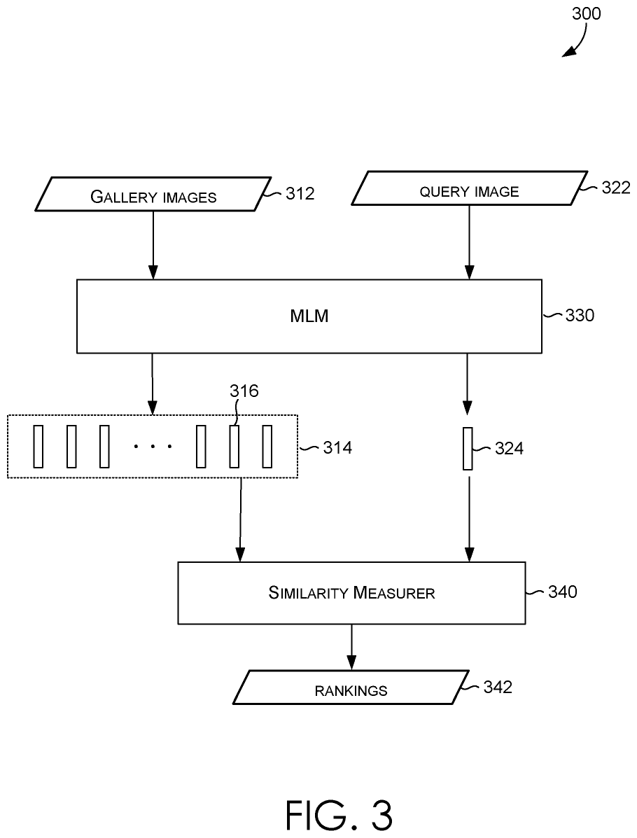

In other embodiments, verification system 170 may activate various components of checkout station 110 in response to a verification code. For example, verification system 170 may activate a warning light or prompt a voice message to convey a message indicating the verification code. The message may include instructions for how user 112 may continue the transaction, such as announcing a suggested product class based on the features of product 124. In some embodiments, the suggested class or classes may be determined by retriever 172, which will be further discussed in connection with FIG. 3.

In addition to other components not shown in FIG. 1, retriever 172, CCMD 174, ICMD 178, enhancer 176, and MLM 160, may be operatively coupled with each other in verification system 170. In various embodiments, retriever 172 is configured to determine the features of an image and, further, to compare the determined features to features of one or more known image classes. In some embodiments, retriever 172 is used to determine a rank among a set of image classes based on their similarity measures against the determined features. Compared to retriever 172, CCMD 174 is configured for verification in a more specificity-attentive manner, e.g., based on deeper features. Similarly, compared to CCMD 174, ICMD 178 is configured for verification in a more specificity-attentive manner, e.g., based on even more deeper features. In some embodiments, enhancer 176 is configured to enhance the discriminative power of the compared features. In this way, verification system 170 may progressively detect mismatches from a generality-attentive manner to a specificity-attentive manner and then to an even deeper specificity-attentive manner.

The aforementioned image features may be learned using various machine learning models, e.g., implemented via MLM 160, which may include one or more neural networks in some embodiments. Retriever 172, enhancer 176, CCMD 174, and ICMD 178 may use different one or more neural networks to achieve their respective functions, which will be further discussed in connection with the remaining figures. As used herein, a neural network comprises at least three operational layers. The three layers can include an input layer, a hidden layer, and an output layer. Each layer comprises neurons. The input layer neurons pass data to neurons in the hidden layer. Neurons in the hidden layer pass data to neurons in the output layer. The output layer then produces a classification. Different types of layers and networks connect neurons in different ways.

Every neuron has weights, an activation function that defines the output of the neuron given an input, including the weights, and an output. The weights are the adjustable parameters that cause a network to produce a correct output. The weights are adjusted during training. Once trained, the weight associated with a given neuron can remain fixed. The other data passing between neurons can change in response to a given input (e.g., image).

The neural network may include many more than three layers. Neural networks with more than one hidden layer may be called deep neural networks. Example neural networks that may be used with aspects of the technology described herein include, but are not limited to, multilayer perceptron (MLP) networks, convolutional neural networks (CNN), recursive neural networks, recurrent neural networks, and long short-term memory (LSTM), which is a type of recursive neural network. Some embodiments described herein use a CNN, but aspects of the technology are applicable to other types of multi-layer machine classification technology.

A CNN may include any number of layers. The objective of one type of layers (e.g., Convolutional, Relu, and Pool) is to extract features of the input volume, while the objective of another type of layers (e.g., fully connected (FC) and Softmax) is to classify based on the extracted features. An input layer may hold values associated with an instance. For example, when the instance is an image(s), the input layer may hold values representative of the raw pixel values of the image(s) as a volume (e.g., a width, W, a height, H, and color channels, C (e.g., RGB), such as W×H×C), or a batch size, B.

One or more layers in the CNN may include convolutional layers. The convolutional layers may compute the output of neurons that are connected to local regions in an input layer (e.g., the input layer), each neuron computing a dot product between their weights and a small region they are connected to in the input volume. In a convolutional process, a filter, a kernel, or a feature detector includes a small matrix used for feature detection. Convolved features, activation maps, or feature maps are the output volume formed by sliding the filter over the image and computing the dot product. An exemplary result of a convolutional layer may include another volume, with one of the dimensions based on the number of filters applied (e.g., the width, the height, and the number of filters, F, such as W×H×F, if F were the number of filters).

One or more of the layers may include a rectified linear unit (ReLU) layer. The ReLU layer(s) may apply an elementwise activation function, such as the max (0, x), thresholding at zero, for example, which turns negative values to zeros (thresholding at zero). The resulting volume of a ReLU layer may be the same as the volume of the input of the ReLU layer. This layer does not change the size of the volume, and there are no hyperparameters.

One or more of the layers may include a pooling layer. A pooling layer performs a function to reduce the spatial dimensions of the input and control overfitting. This layer may use various functions, such as Max pooling, average pooling, or L2-norm pooling. In some embodiments, max pooling is used, which only takes the most important part (e.g., the value of the brightest pixel) of the input volume. By way of example, a pooling layer may perform a downsampling operation along the spatial dimensions (e.g., the height and the width), which may result in a smaller volume than the input of the pooling layer (e.g., 16×16×12 from the 32×32×12 input volume). In some embodiments, the convolutional network may not include any pooling layers. Instead, strided convolutional layers may be used in place of pooling layers.

One or more of the layers may include a FC layer. A FC layer connects every neuron in one layer to every neuron in another layer. The last FC layer normally uses an activation function (e.g., Softmax) for classifying the generated features of the input volume into various classes based on the training dataset. The resulting volume may take the form of 1×1×number of classes.

Further, calculating the length or magnitude of vectors is often required either directly as a regularization method in machine learning, or as part of broader vector or matrix operations. The length of the vector is referred to as the vector norm or the vector's magnitude. The L1 norm is calculated as the sum of the absolute values of the vector. The L2 norm is calculated as the square root of the sum of the squared vector values. The max norm is calculated as the maximum vector values.

As discussed previously, some of the layers may include parameters (e.g., weights or biases), such as a convolutional layer, while others may not, such as the ReLU layers and pooling layers, for example. In various embodiments, the parameters may be learned or updated during training. Further, some of the layers may include additional hyper-parameters (e.g., learning rate, stride, epochs, kernel size, number of filters, type of pooling for pooling layers, etc.), such as a convolutional layer or a pooling layer, while other layers may not, such as a ReLU layer. Various activation functions may be used, including but not limited to, ReLU, leaky ReLU, sigmoid, hyperbolic tangent (tanh), exponential linear unit (ELU), etc. The parameters, hyper-parameters, or activation functions are not to be limited and may differ depending on the embodiment.

Although input layers, convolutional layers, pooling layers, ReLU layers, and fully connected layers are discussed herein, this is not intended to be limiting. For example, additional or alternative layers, such as normalization layers, Softmax layers, or other layer types, may be used in a CNN.

Different orders and layers in a CNN may be used depending on the embodiment. For example, when verification system 170 is used in practical applications for loss prevention (e.g., with emphasis on product-oriented action recognition), there may be one order and one combination of layers; whereas when verification system 170 is used in practical applications for crime prevention in public areas (e.g., with emphasis on person-oriented action recognition), there may be another order and another combination of layers. In other words, the layers and their order in a CNN may vary without departing from the scope of this disclosure.

Although many examples are described herein concerning using neural networks, and specifically convolutional neural networks, this is not intended to be limiting. For example, and without limitation, MLM 160 may include any type of machine learning models, such as a machine learning model(s) using linear regression, logistic regression, decision trees, support vector machines (SVM), Naïve Bayes, k-nearest neighbor (KNN), K means clustering, random forest, dimensionality reduction algorithms, gradient boosting algorithms, neural networks (e.g., auto-encoders, convolutional, recurrent, perceptrons, long or short term memory/LSTM, Hopfield, Boltzmann, deep belief, deconvolutional, generative adversarial, liquid state machine, etc.), or other types of machine learning models.

Verification system 170 is merely one example of a suitable computing environment and is not intended to suggest any limitation as to the scope of use or functionality of aspects of the technologies described herein. Neither should this system be interpreted as having any dependency or requirement relating to any one component nor any combination of components illustrated.

It should be understood that this arrangement of various components in verification system 170 is set forth only as an example. Other arrangements and elements (e.g., machines, networks, interfaces, functions, orders, and grouping of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by an entity may be carried out by hardware, firmware, or software. For instance, some functions may be carried out by a processor executing instructions stored in memory.

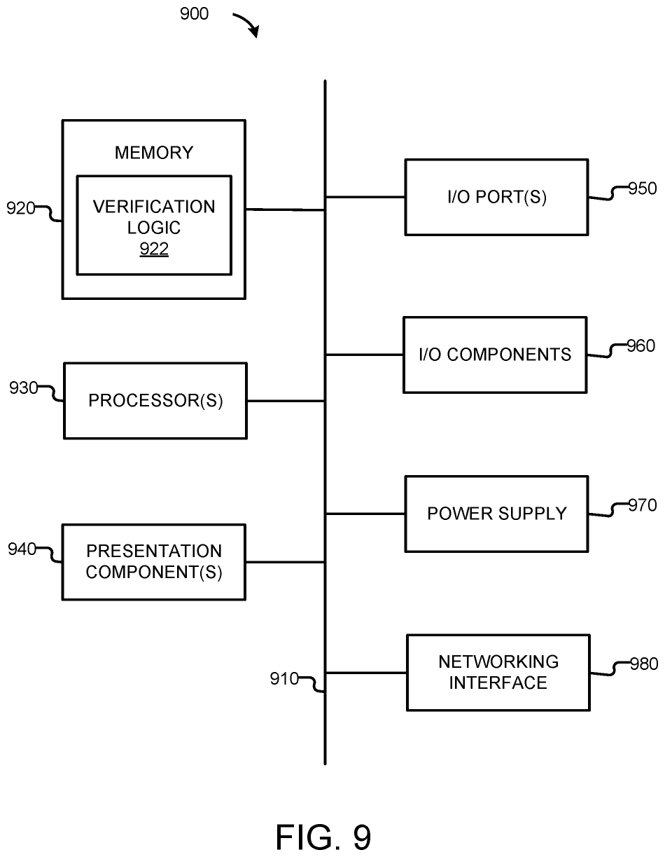

It should be understood that each of the components shown in verification system 170 may be implemented on any type of computing device, such as computing device 900 described in FIG. 9. Further, each of the components may communicate with various external devices via a network, which may include, without limitation, a local area network (LAN) or a wide area network (WAN).

FIG. 2 illustrates an exemplary verification process (process 200) in accordance with at least one aspect of the technologies described herein. In this embodiment, four different thresholds are used to enable multiple progressive exits from this exemplary verification process. Each exit represents either a positive or negative verification outcome.

Input 202 is a query image, e.g., an image of product 124 captured by camera 118 in FIG. 1. The query image first goes into retriever 204. Retriever 204 can return a ranking based on the similarity between the query image and a set of known image classes. The top-ranked image classes may be used for automatic product recognition or mismatch correction.

In one embodiment, the top-ranked image classes are displayed to users. For instance, in connection with FIG. 1, the top-ranked image classes may be displayed on display 116, e.g., based on the ranking determined by retriever 172 after comparing the product image of product 124 against all or a part of image classes corresponding to price look-up (PLU) codes in a store. Further, user 112 may select a particular image class with a rank (rank_selected).

This rank_selected may be compared with threshold 206, which is an integer predetermined or dynamically determined based on the actual practical application. If the rank_selected is higher than threshold 206, process 200 will output positive verification code 208. By way of example, a store may set threshold 206 as three, and if the rank_selected is one, which is higher than three, a positive verification code will be generated, which means the selected image class matches the selected image class based on threshold 206. Accordingly, process 200 may exit.

If the rank_selected is lower than threshold 206, CCMD 212 is triggered. As used herein, depending on the practical implementations, higher, above, or greater than refers to (>) or (>=) mathematical conditions, and lower, below, or lesser than refers to (<) or (<=) mathematical conditions. The boundary condition of equal (==) is covered in at least one branch of the verification flow subject to the actual implementation.

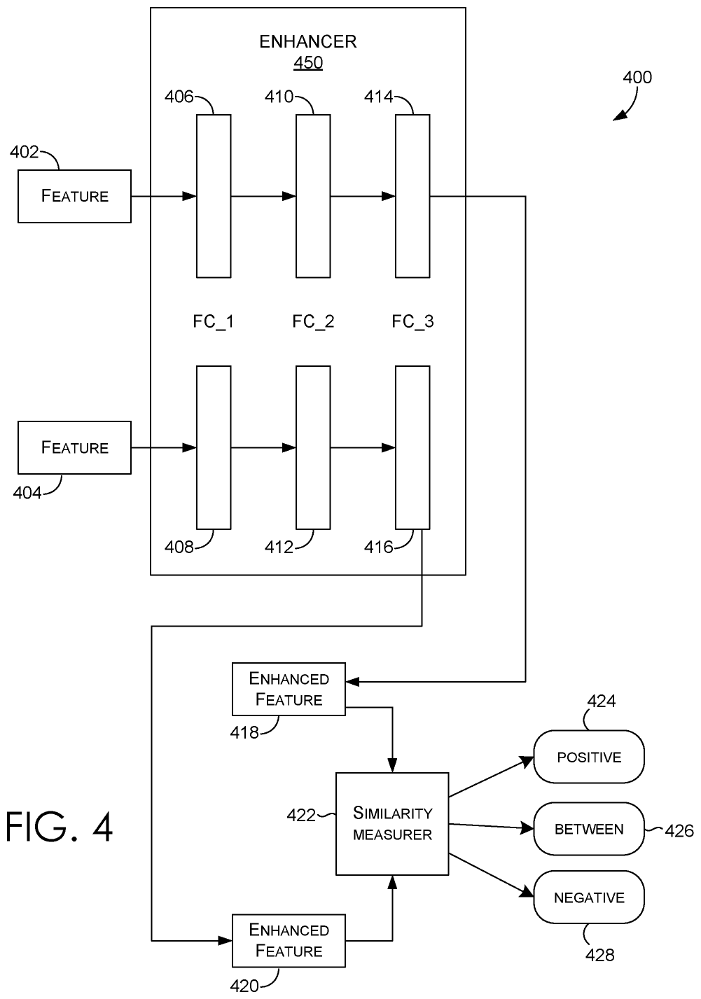

After CCMD 212 is triggered, CCMD 212 may take the query image feature and the image feature of the selected image class as inputs and return a mismatch detection score (CCMD_score), as will be further discussed in connection with FIG. 4.

If the CCMD_score is above threshold 214, process 200 may exit with positive verification code 216. If the CCMD_score is below threshold 218, process 200 may exit with negative verification code 220, which indicates a detected mismatch. If the CCMD_score is between threshold 214 and threshold 218, ICMD 222 will be triggered.

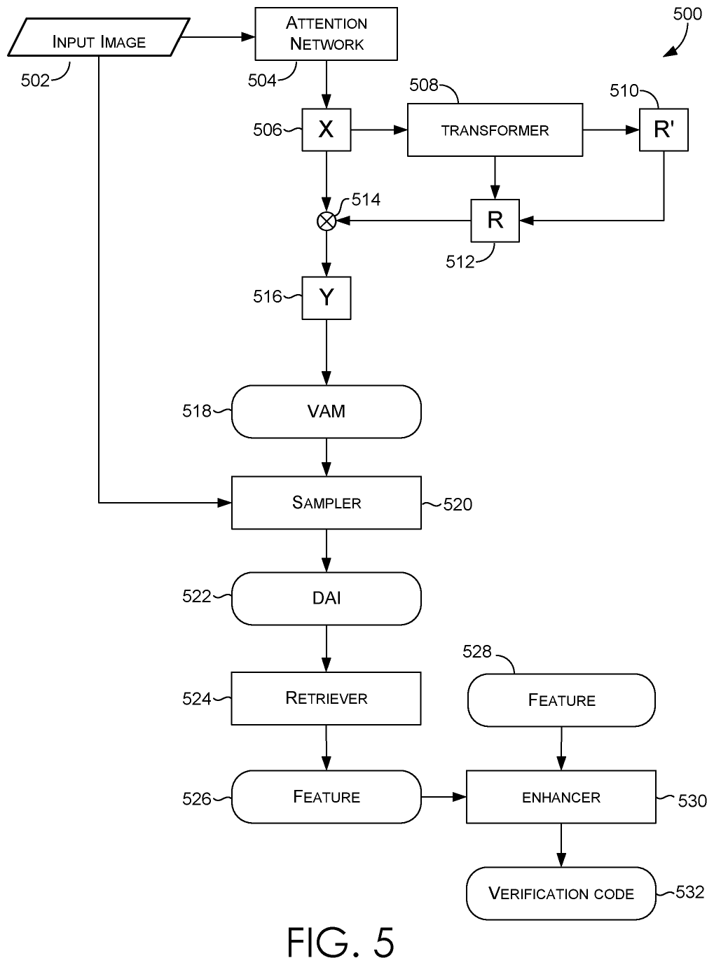

In some embodiments, ICMD 222 first generates a transformed image in which discriminative details of input 202 are amplified, and the feature of the transformed image may be further obtained and compared to the image feature of the selected image class. ICMD 222 can return a mismatch detection score (ICMD score), which will be further discussed in connection with FIG. 5. If ICMD score is above threshold 224, process 200 may exit with positive verification code 228. If the ICMD score is below threshold 224, process 200 may exit with negative verification code 226, which indicates a detected mismatch.

Although process 200 may exit progressively after comparing with threshold 206, threshold 214, threshold 218, and threshold 224, each threshold may be determined independently based on respective machine learning models used by retriever 204, CCMD 212, and ICMD 222.

Referring now to FIG. 3, a schematic representation is provided illustrating an exemplary process in an exemplary retriever 300, similar to retriever 172 in FIG. 1 or retriever 204 in FIG. 2. In various embodiments, a retriever is to determine the features of a query image based on a trained machine learning model. Further, the retriever can determine a rank among a set of image classes based on their similarity measures against the features of the query image.

Query image 322 is the target image for a query, e.g., an image of product 124 in connection with FIG. 1. Gallery images 312 include preexisting images of requisite image classes, e.g., images of all or a part of products in a store. MLM 330 is trained to extract feature 324 from query image 322 and features 314 from gallery images 312. The former extraction is usually an online process or happens in real-time or near real-time, while the later extraction may be alternatively conducted offline when gallery images 312 is available.

In some embodiments, MLM 330 includes one or more neural networks (e.g., ResNet-50) with an additional fully-connected layer at the end for feature dimensionality reduction. Feature 324 from query image 322 takes the form as a feature vector in some embodiments. Gallery images 312 may include multiple images of a common class, e.g., 10 images of different views of the same product. In this case, MLM 330 is to develop a mean feature for the class, e.g., by performing average-pooling (followed by L2-norm) for all the features of all images in the class to form a mean feature per class.

At run-time, similarity measurer 340 measures feature 324 against every feature in features 314. In some embodiments, cosine similarity is used to gauge the similarity between two feature vectors. Accordingly, rankings 342, which is a ranking of the known image classes as represented by features 314, can be obtained by sorting the similarity scores. For instance, if the similarity score between feature 316 and feature 324 is the highest, the image class represented by feature 316 will receive the highest rank in rankings 342. In various embodiments, only top ranked classes may be returned depending on the specific application.

FIG. 4 is a schematic representation illustrating an exemplary process with an exemplary CCMD 400, similar to CCMD 174 of FIG. 1 or CCMD 212 of FIG. 2. which utilizes an enhancer (e.g., enhancer 176 of FIG. 1). Compared to the verification process in a retriever, the verification process in a CCMD is executed in a specificity-attentive manner, e.g., based on enhanced features of the query image. In various embodiments, from a retriever to a CCMD, the verification process also progresses from a generality-attentive manner to a specificity-attentive manner. Using an analogy, if a retriever is to verify with naked eyes, then a CCMD is to verify with a magnifier.

Enhancer 450 is to enhance the discriminative power of feature 402 and feature 404. In various embodiments, enhancer 450 includes a neural network, which may be trained to enhance mismatch discriminative power, e.g., based on a Softmax function (e.g., Eq. 1) and a cross-entropy loss (e.g., Eq. 2), where C denotes the number of classes (e.g., set to 2 for two classes, i.e., match and mismatch), and i and j denote the i^{th} or j^{th} class.

$$\begin{matrix}{f ( s )}_{i} = \frac{{e}^{S} i}{{\sum }_{j}^{C} {e}^{{S}_{i}}} & Eq . 1 \\ CE = - {\sum }_{i}^{C} log ( {f ( s )}_{i} ) & Eq . 2\end{matrix}$$

For a mismatched pair, the cross-entropy loss pushes the similarity to 0, while for a matched pair, the cross-entropy loss pushes the similarity to 1. In various embodiments, to train the neural network in enhancer 450, soft labels are used for the training data. The soft label is formed with a first mean being less than 1.0 to represent positive pairs of input feature vectors, and a second mean being greater than 0.0 to represent negative pairs of input feature vectors. For example, positive pairs of feature vectors of the same class may be labeled with a distribution (e.g., Gaussian distribution) with a mean less than 1.0 (e.g., 0.8). Negative pairs of feature vectors of different classes may be labeled with a distribution (e.g., Gaussian distribution) with a mean greater than 0.0 (e.g., 0.2). In one embodiment, the cross-entropy loss is configured to push the similarity to 0.2 for a mismatched pair and to 0.8 for a matched pair. Advantageously, training enhancer 450 with soft labels may prevent the undesirable binalization effect in some conventional systems, where the predicted similarity scores become very close either to 1 or 0 and hardly any cases in between.

After training, enhancer 450 is to produce enhanced features for differentiation, such as the similarity measure of a pair of feature vectors of a same class (i.e., a match) is close to 0, while the similarity measure of a pair of feature vectors of different classes (i.e., a mismatch) is close to 1.

In some embodiments, the neural network has three fully-connected layers (FCL). FCL 406, FCL 410, and FCL 414 are used to transform feature 402 to enhanced feature 418. Similarly, FCL 408, FCL 412, and FCL 416 are used to transform feature 404 to enhanced feature 420. In some embodiments, the output from enhancer 450 is L2-normalized to produce the enhanced feature. Enhanced feature 418 and enhanced feature 420 may share the same channel size as feature 402 or feature 404. In some embodiments, the first set of FCLs (i.e., FCL 406, FCL 410, and FCL 414) and the second set of FCLs (i.e., FCL 408, FCL 412, and FCL 416) share the same technical characteristics or parameters, such as the channel size (e.g., 256), hyperparameters, etc. In some embodiments, feature 402 and feature 404 may be concatenated first before going into enhancer 450, which may be composed by FCL 406, FCL 410, and FCL 414 only. The enhanced feature may be divided afterwards.

A skilled artisan may understand that the neural network in enhancer 450 may be designed differently (e.g., with different layers or number of layers) and trained with a different loss function to also enhance mismatch discriminative power of its input features. A skilled artisan may also understand that a neural network with only one set of FCLs can also achieve equivalent design and function as illustrated in enhancer 450.

In various embodiments, enhanced feature 418 and enhanced feature 420 are measured for their similarity in similarity measurer 422, e.g., based on the cosine similarity of the two feature vectors. In connection with FIG. 2, three pathways exits from a CCMD based on two thresholds and the similarity measure between enhanced feature 418 and enhanced feature 420. Namely, the verification process now can output a positive verification code at pathway 424, a negative verification code at pathway 428, and also enter into an ICMD-based verification pathway 426, which will be further discussed in connection with FIG. 5.

FIG. 5 is a schematic representation illustrating an exemplary process with an exemplary ICMD 500, similar to ICMD 178 of FIG. 1 or ICMD 222 of FIG. 2. In some embodiments, ICMD 500 is first to generate a variational attention map (VAM) from input image 502 (e.g., an image of product 124) using a variational trilinear transformation.

To do that, attention network 504 will generate feature map 506, denoted as X, from input image 502 first. Next, transformer 508, e.g., using a bilinear transformation on X, may determine channel-wise spatial relations (CWSR) 512 of X, denoted as R. A summation along one direction of R leads to vector 510, denoted as R′, which is a C dimensional vector, where C is the number of channels in input image 502. Softmax function may be applied on R′. As different channels may capture different local features of input image 502, after the bilinear transformation, the value on each dimension of R′ may be used to indicate the importance of that channel for the verification of input image 502.

During training, a subset S (e.g., 16 channels) of channels of X (e.g., 256 channels) may be sampled based on R′ in a variational manner. Further, by removing the unsampled channels in R, many subsets with each as a C-by-S dimensional matrix may be obtained. Further, X multiples with the C subsets leads to vectors 516, denoted as Y, which may be obtained based on Eq. 3. Regarding Eq. 3, R_binary and R′ are C-dimensional. R_binary is a binary vector, in which only the sampled S elements equal to 1, and the rest elements are 0; and topk_Gumbel_softmax is a function to sample S elements based on R′.

Y=R_{binary}*X,R_{binary}=topk_Gumble_softmax(R′) Eq. 3

Next, average-pooling may be applied on Y along the channel dimension to give variational attention map (VAM) 518, thus completes this variational trilinear transformation. VAM 518 contains information to differentiate the different regions of input image 502 based on their respective discriminative features, thus their respective importance for verification. In various embodiments, during training, VAM 518 contains a subset of channels of X During inference, VAM 518 contains all channels of X, e.g., by sum-pooling on X along the channel dimension.

Regarding the subset sampling process in the variational trilinear transformation, the variational subset sampling method (VSSM) may be performed based on Softmax (R′) in some embodiments since some channels are more important than the other for verification. To obtain a discrete output from a continuous distribution (e.g., Softmax(R′)), techniques of reparameterization by top-k Gumbel-Softmax may be used. This continuous relaxation makes the subset sampling procedure differentiable, such that the neural network can be trained in an end-to-end manner. The VSSM is differentiable as the probability for a channel to be sampled depends on Softmax (R′), the configuration of the current network (e.g., current weights), and the input image itself.

Comparing to the random sampling method, the disclosed VSSM encourages the sampling of the more important channels, thus improving the training efficiency. Comparing to using all channels, the disclosed VSSM naturally generates more training data, and thus also serves as a data augmentation technique for training the network. Advantageously, this disclosed VSSM also serves as a very important regularization function for preventing the deep neural networks from overfitting. As a result, the disclosed VSSM is very robust to the noise in the training data, thus applicable in various machine learning tasks and diverse data sets. A skilled artisan may understand that at the inference time, all channels of CWSR 512 may be used to generate vectors 516 without implementing the VSSM.

Based on VAM 518, sampler 520 can produce a detail-attentive image (DAI) 522 from input image 502. Sampler 520 may be a non-uniform sampler in various embodiments. DAI 522 becomes a derivative image of input image 502 with the differential transformation of various regions based on VAM 518, so that the discriminative features of input image 502 may be emphasized or magnified for verification. In other words, DAI 522 is detail-attentive to the discriminative features of input image 502. By way of example, all types of apples are within the same Apple class, but different types of apples may have their respective visual discriminative features. Fuji apples are bi-colored, typically stripped with yellow and red. Goldens have a pale-yellow skin, sometimes with a red blush. Galas can vary in color, from cream to red-striped or yellow-striped. If the input image is an apple, the discriminative features of this particular type of apple will be emphasized or magnified in DAI 522.

Feature 526 may be extracted by retriever 524 from DAI 522, e.g., in a similar process as discussed with FIG. 3. In some embodiments, feature 526 may be directly compared with feature 528 (e.g., the features of the image class represented by image 122) for similarity. In other embodiments, feature 526 and feature 528 may go through enhancer 530 for their similarity measurement, e.g., in a similar process as discussed with FIG. 4. Different from the CCMD process, there may only be one threshold required in the ICMD process, as discussed with FIG. 2. Resultantly, verification code 532 represents either a positive or negative verification code depending on the comparison between the similar score and the ICMD threshold.

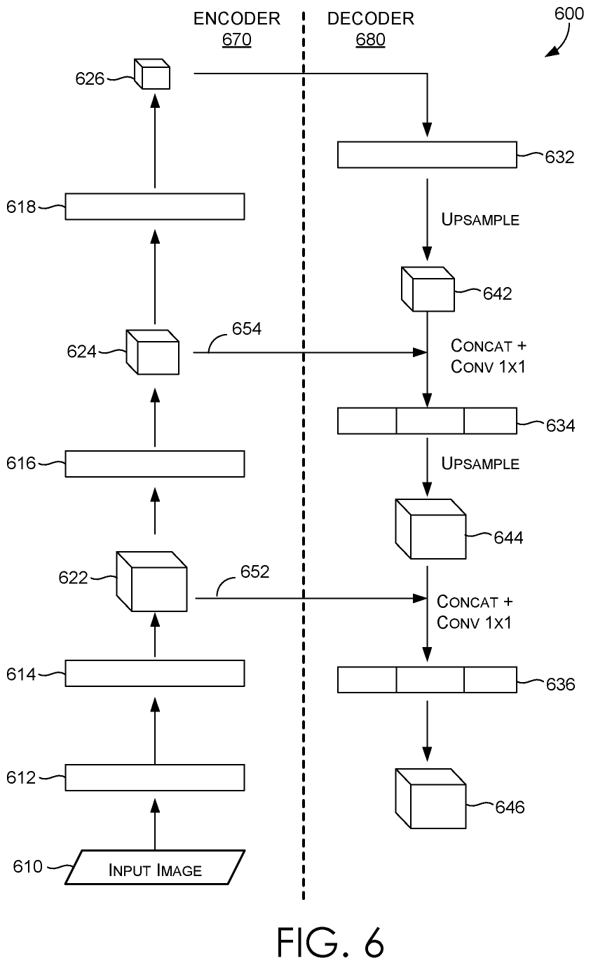

FIG. 6 is a schematic representation illustrating an exemplary process with an exemplary attention network 600. In connection with FIG. 5, attention network 600 is configured to generate a feature map from an image. Traditional neural networks such as VGG and ResNet are good at classification tasks. Downsampling usually is applied in these traditional networks to obtain the final feature map, which is usually the spatially smallest feature map. However, the feature map generated by attention network 600 is used for detail localization, rather than classification. Therefore, a unique encoder-decoder structure is designed for attention network 600 to produce high-resolution feature maps while maintaining high-level semantics. High-resolution feature maps mean that the feature map (W×H×C, for Width×Height×Channel) has a high resolution spatial-wise in terms of W×H. A W×H threshold may be defined depending on the specific application, and a feature map greater than the W×H threshold becomes a high-resolution feature map. Meanwhile, semantics or high-level semantics refers to the global information, e.g., what the object about, instead of the local or low-level details, e.g., texture, edge, line, etc.

In various embodiments, attention network 600 has an encoder-decoder structure, such as encoder 670 on the left and decoder 680 on the right as illustrated in FIG. 6. In this embodiment, each convolutional layer (layer 612, layer 614, layer 616, and layer 618) in encoder 670 uses a dilation rate of 1. In decoder 680, each of convolutional module 634 and convolutional module 636 consists of three branches. The three branches share the same parameters but use different dilation rates, e.g., 1, 2 and 3. The outputs of the three branches may be merged via element-wise summation. This unique design can enlarge the receptive fields of the feature maps in decoder 680 to capture more high-level semantics, e.g., by using a dilation rate larger than 1. At the same time, decoder 680 can retain its attentiveness to fine details or local features, e.g., by using the dilation rate of 1 in layer 632.

From input image 610, encoder 670 progressively generates feature maps 622, 624, and 626 with decreasing spatial sizes, while decoder 680 progressively generates feature maps 642, 644, and 646 with increasing spatial sizes. Further, shortcut 652 and shortcut 654 are designed to enable the low-level information in encoder 670 to directly flow to decoder 680, e.g., by using a channel-wise concatenation operation followed by a convolutional operation with a 1×1 kernel.

These shortcuts achieve two objectives. First, the concatenation operation is to gather the low-level information. Second, the convolutional operation with a 1×1 kernel can reduce the concatenated feature map dimension back to the original size, i.e., the half of the concatenated feature. Resultantly, these shortcuts alleviate the information lost due to the continuous downsampling in encoder 670.

In one embodiment, all the convolutional layers in the attention network use depthwise separable convolution (DSC), instead of the standard convolution. Using DSC can speed up the forward and backward pass of the network, as well as reducing the parameters of the network. Advantageously, faster inference speed achieved with DSC in a practical application can greatly improve the experience of the users. Further, as the correlation between channels in the feature maps can be explicitly captured in the variational trilinear transformation by the VSSM in connection with FIG. 5, the advantages of using this light-weight and expeditious operation (i.e. DSC) may be achieved without sacrificing the performance or accuracy.

In a particular experiment, layer 612 uses a kernel of 7×7 with 64 channels, stride of 2, and followed by a max-pooling of 3×3. Layer 614 uses a 3×3 kernel with 128 bits channel and stride of 2. Layer 616 uses a 3×3 kernel with 256 channels and stride of 2. Layer 618 uses a 3×3 kernel with 512 channel and stride of 2. Layer 632 uses a 3×3 kernel with 256 channels and stride of 2. Convolutional modules 634 and 636 includes three branches of convolutional layers using 3×3 kernels with 128 channels. Finally, feature map 646 becomes 128 bits, which is downsampled by a factor, e.g., 8, from input image 610. In other embodiments, different factors may be chosen to generate a final feature map with a fair resolution because if a too small resolution (e.g., downsampled by 32) would leads to information loss, but a too high resolution (downsampled by 2) would slow down the computation and hog the memory.

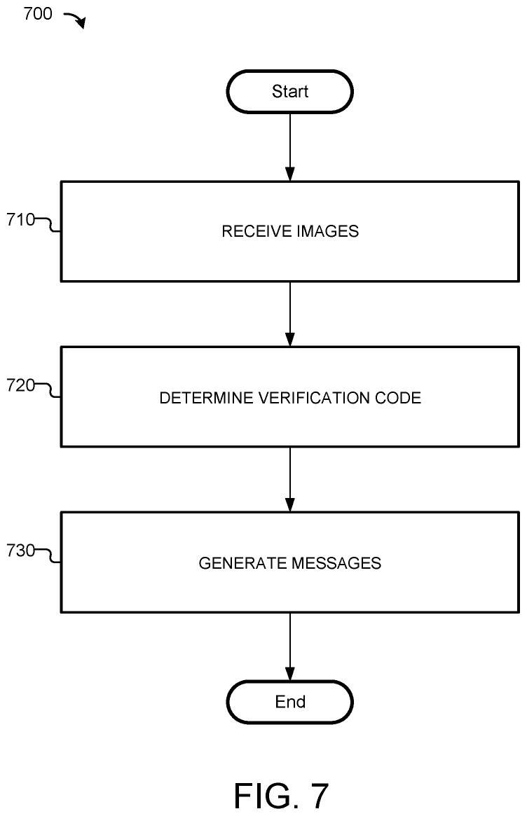

FIG. 7 is a flow diagram illustrating an exemplary process 700 for verification. Each block of process 700, and other processes described herein, comprises a computing process that may be performed using any combination of hardware, firmware, or software. For instance, various functions may be carried out by a processor executing instructions stored in memory. The process may also be embodied as computer-usable instructions stored on computer storage media or devices. The process may be provided by an application, a service, or in combination thereof.

At block 710, the process is to receive images, e.g., verification system 170 to receive images captured by camera 118 of FIG. 1.

At block 720, the process is to determine verification codes, e.g., by verification system 170 with process 200. As discussed previously, verification system 170 is designed to progressively detect mismatches from a generality-attentive manner to a specificity-attentive manner and then to an even deeper specificity-attentive manner.

Various exit points are designed in the verification process to enable the disclosed system to execute verification tasks based on their respective inherited complexities. A complex verification task may be executed in a specificity-attentive manner. A simple verification task may be executed in a faster generality-attentive manner. As not all verification tasks need to run through all progressive stages in the disclosed verification process, the overall computing efficacy is improved. User experiments with the disclosed system are significantly improved with the fast verification responses.

At block 730, the process is to generate messages based on the verification code. The scope and content of the message may be designed based on the particular practical application. In a loss prevention application, a negative verification code may be reported in real-time or near real-time. In response to a negative verification code, a message may be generated and distributed to one or more designated devices, such as a checkout machine or a mobile device accessible to a loss prevention team. The message may include information about the negative verification code, one or more representative images related to the reportable action, a video clip of the reportable action, a remedy, a protocol for handling the reportable action, etc.

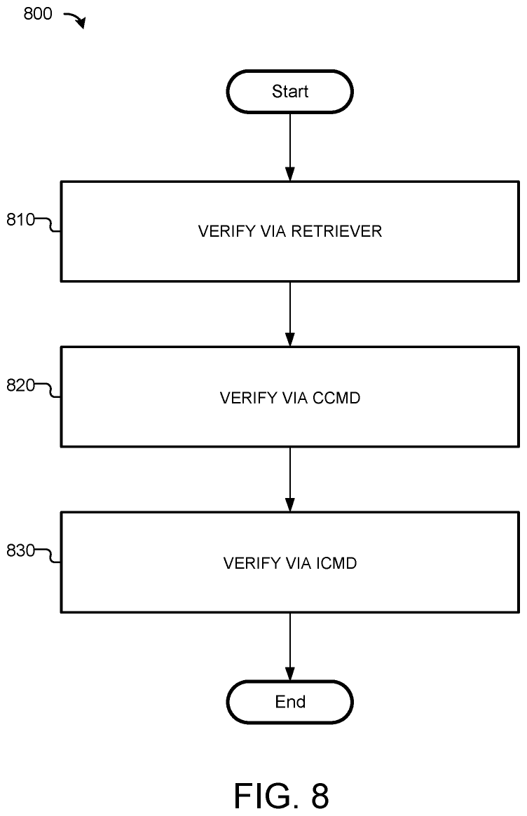

FIG. 8 is a flow diagram illustrating another exemplary process 800 for verification. Each block of process 800, and other processes described herein, comprises a computing process that may be performed using any combination of hardware, firmware, or software. For instance, various functions may be carried out by a processor executing instructions stored in memory. The processes may also be embodied as computer-usable instructions stored on computer storage media or devices. The process may be provided by an application, a service, or in combination thereof. In various embodiments, process 800 may be performed in relation to block 720 of FIG. 7.

At block 810, the process is configured for verification via a retriever, discussed in detail in connection with FIG. 3.

At block 820, the process is configured for verification via a CCMD, discussed in detail in connection with FIG. 4.

At block 830, the process is configured for verification via an ICMD, discussed in detail in connection with FIG. 5.

Accordingly, we have described various aspects of the disclosed technologies for video recognition. Each block in process 800 and other processes described herein comprises a computing process that may be performed using any combination of hardware, firmware, or software. For instance, various functions may be carried out by a processor executing instructions stored in memory. The processes may also be embodied as computer-usable instructions stored on computer storage media or devices. The process may be provided by an application, a service, or a combination thereof.

It is understood that various features, sub-combinations, and modifications of the embodiments described herein are of utility and may be employed in other embodiments without reference to other features or sub-combinations. Moreover, the order and sequences of steps or blocks shown in the above example processes are not meant to limit the scope of the present disclosure in any way and the steps or blocks may occur in a variety of different sequences within embodiments hereof. Such variations and combinations thereof are also contemplated to be within the scope of embodiments of this disclosure.

Referring to FIG. 9, an exemplary operating environment for implementing various aspects of the technologies described herein is shown and designated generally as computing device 900. Computing device 900 is but one example of a suitable computing environment and is not intended to suggest any limitation as to the scope of use of the technologies described herein. Neither should the computing device 900 be interpreted as having any dependency or requirement relating to any one or combination of components illustrated.

The technologies described herein may be described in the general context of computer code or machine-useable instructions, including computer-executable instructions, such as program components, being executed by a computer or other machine. Generally, program components, including routines, programs, objects, components, data structures, and the like, refer to code that performs particular tasks or implements particular abstract data types. The technologies described herein may be practiced in a variety of system configurations, including handheld devices, consumer electronics, general-purpose computers, and specialty computing devices, etc. Aspects of the technologies described herein may also be practiced in distributed computing environments where tasks are performed by remote-processing devices that are connected through a communications network.

With continued reference to FIG. 9, computing device 900 includes a bus 910 that directly or indirectly couples the following devices: memory 920, processors 930, presentation components 940, input/output (I/O) ports 950, I/O components 960, and an illustrative power supply 970. Bus 910 may include an address bus, data bus, or a combination thereof. Although the various blocks of FIG. 9 are shown with lines for the sake of clarity, in reality, delineating various components is not so clear and, metaphorically, the lines would more accurately be grey and fuzzy. For example, one may consider a presentation component, such as a display device, to be an I/O component. The inventors hereof recognize that such is the nature of the art and reiterate the diagram of FIG. 9 is merely illustrative of an exemplary computing device that can be used in connection with different aspects of the technologies described herein. Distinction is not made between such categories as “workstation,” “server,” “laptop,” “handheld device,” etc., as all are contemplated within the scope of FIG. 9 and refers to “computer” or “computing device.”

Computing device 900 typically includes a variety of computer-readable media. Computer-readable media can be any available media that can be accessed by computing device 900 and includes both volatile and nonvolatile media as well as removable and non-removable media. By way of example, and not limitation, computer-readable media may comprise computer storage media and communication media. Computer storage media includes both volatile and nonvolatile, removable and non-removable media implemented in any method or technologies for storage of information, such as computer-readable instructions, data structures, program modules, or other data.

Computer storage media includes RAM, ROM, EEPROM, flash memory or other memory technologies, CD-ROM, digital versatile disks (DVD), or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal, such as a carrier wave or other transport mechanism, and includes any information delivery media. The term “modulated data signal” means a signal that has its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer-readable media.

Memory 920 includes computer storage media in the form of volatile or nonvolatile memory. The memory 920 may be removable, non-removable, or a combination thereof. Exemplary memory includes solid-state memory, hard drives, optical-disc drives, etc. Computing device 900 includes processors 930 that read data from various entities, such as bus 910, memory 920, or I/O components 960. Presentation component(s) 940 present data indications to a user or other device. Exemplary presentation components 940 include a display device, speaker, printing component, vibrating component, etc. I/O ports 950 allow computing device 900 to be logically coupled to other devices, including I/O components 960, some of which may be built-in.

In various embodiments, memory 920 includes, in particular, temporal and persistent copies of verification logic 922. Verification logic 922 includes instructions that, when executed by processor 930, result in computing device 900 performing functions, such as but not limited to, process 700, process 800, or other processes discussed herein. In various embodiments, verification logic 922 includes instructions that, when executed by processors 930, result in computing device 900 performing various functions associated with, but not limited to, various components in connection with verification system 170 in FIG. 1 and various components in connection in connection with FIGS. 2-6.

In some embodiments, processors 930 may be packed together with verification logic 922. In some embodiments, processors 930 may be packaged together with verification logic 922 to form a System in Package (SiP). In some embodiments, processors 930 can be integrated on the same die with verification logic 922. In some embodiments, processors 930 can be integrated on the same die with verification logic 922 to form a System on Chip (SoC).

Illustrative I/O components include a microphone, joystick, gamepad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided to digitally capture freehand user input. The connection between the pen digitizer and processor(s) 930 may be direct or via a coupling utilizing a serial port, parallel port, system bus, or other interface known in the art. Furthermore, the digitizer input component may be a component separate from an output component, such as a display device. In some aspects, the usable input area of a digitizer may coexist with the display area of a display device, be integrated with the display device, or may exist as a separate device overlaying or otherwise appended to a display device. Any such variations, and any combination thereof, are contemplated to be within the scope of aspects of the technologies described herein.

I/O components 960 include various GUI, which allow users to interact with computing device 900 through graphical elements or visual indicators. Interactions with a GUI usually are performed through direct manipulation of graphical elements in the GUI. Generally, such user interactions may invoke the business logic associated with respective graphical elements in the GUI. Two similar graphical elements may be associated with different functions, while two different graphical elements may be associated with similar functions. Further, the same GUI may have different presentations on different computing devices, such as based on the different graphical processing units (GPUs) or the various characteristics of the display.

Computing device 900 may include networking interface 980. The networking interface 980 includes a network interface controller (NIC) that transmits and receives data. The networking interface 980 may use wired technologies (e.g., coaxial cable, twisted pair, optical fiber, etc.) or wireless technologies (e.g., terrestrial microwave, communications satellites, cellular, radio and spread spectrum technologies, etc.). Particularly, the networking interface 980 may include a wireless terminal adapted to receive communications and media over various wireless networks. Computing device 900 may communicate with other devices via the networking interface 980 using radio communication technologies. The radio communications may be a short-range connection, a long-range connection, or a combination of both a short-range and a long-range wireless telecommunications connection. A short-range connection may include a Wi-Fi® connection to a device (e.g., mobile hotspot) that provides access to a wireless communications network, such as a wireless local area network (WLAN) connection using the 802.11 protocol. A Bluetooth connection to another computing device is a second example of a short-range connection. A long-range connection may include a connection using various wireless networks, including 1G, 2G, 3G, 4G, 5G, etc., or based on various standards or protocols, including General Packet Radio Service (GPRS), Enhanced Data rates for GSM Evolution (EDGE), Global System for Mobiles (GSM), Code Division Multiple Access (CDMA), Time Division Multiple Access (TDMA), Long-Term Evolution (LTE), 802.16 standards, etc.

The technologies described herein have been described in relation to particular aspects, which are intended in all respects to be illustrative rather than restrictive. While the technologies described herein are susceptible to various modifications and alternative constructions, certain illustrated aspects thereof are shown in the drawings and have been described above in detail. It should be understood, however, there is no intention to limit the technologies described herein to the specific forms disclosed, but on the contrary, the intention is to cover all modifications, alternative constructions, and equivalents falling within the spirit and scope of the technologies described herein.

Lastly, by way of example, and not limitation, the following examples are provided to illustrate various embodiments per at least one aspect of the disclosed technologies.

Examples in the first group comprises a method, a computer system adapted to perform the method, or a computer storage device storing computer-usable instructions that cause a computer system to perform the method.

Example 1 in the first group includes operations for receiving a first image of a first object and a second image of a second object; determining a verification code between the first object and the second object with a plurality of progressive stages that include a stage of cross-class mismatch detection and a stage of inner-class mismatch detection; and generating an electronic message to indicate the verification code.

Example 2 may include any subject matter of examples in the first group, and further specify that the first image is captured via a camera operably coupled with a checkout machine, and the second image is selected by a user via a user interface on the checkout machine.

Example 3 may include any subject matter of examples in the first group, and further include operations for extracting, via a first neural network, a first feature vector of the first image; and computing a first similarity measure between the first feature vector and a second feature vector of the second image.

Example 4 may include any subject matter of examples in the first group, and further includes operations for generating a positive verification code in response to the first similarity measure being above a first threshold.

Example 5 may include any subject matter of examples in the first group, and further includes operations for invoking the stage of cross-class mismatch detection in response to the first similarity measure being below a first threshold.

Example 6 may include any subject matter of examples in the first group, and further includes operations for transforming, via a second neural network in the stage of cross-class mismatch detection, the first feature vector and the second feature vector to become a first enhanced feature vector and a second enhanced feature vector respectively, wherein the second neural network is trained with a loss function to enhance mismatch discriminative power; and computing a second similarity measure between the first enhanced feature vector and the second enhanced feature vector.

Example 7 may include any subject matter of examples in the first group, and further includes operations for generating a positive verification code in response to the second similarity measure being above a second threshold; generating a negative verification code in response to the second similarity measure being below a third threshold; and invoking the stage of inner-class mismatch detection in response to the second similarity measure being between the second threshold and the third threshold.

Example 8 may include any subject matter of examples in the first group, and further includes operations for generating, via a variational trilinear transformation process, a variational attention map from the first image; producing, via a non-uniform sampler, a detail-attentive image from the first image based on the variational attention map; and extracting, via a first neural network, a feature vector of the detail-attentive image.

Example 9 may include any subject matter of examples in the first group, and further includes operations for computing a third similarity measure between the feature vector of the detail-attentive image and another feature vector of the second image; in response to the third similarity measure being above a fourth threshold, generating a positive verification code; and in response to the third similarity measure being below the fourth threshold, generating a negative verification code.

Example 10 may include any subject matter of examples in the first group, and further includes operations for transforming, via a second neural network in the stage of inner-class mismatch detection, the feature vector of the detail-attentive image and another feature vector of the second image to a first enhanced feature vector and a second enhanced feature vector respectively, wherein the second neural network is trained with a loss function to enhance mismatch discriminative power of output of the second neural network; computing a third similarity measure between the first enhanced feature vector and the second enhanced feature vector; in response to the third similarity measure being above a fourth threshold, generating a positive verification code; and in response to the third similarity measure being below the fourth threshold, generating a negative verification code.

Examples in the second group comprises a method, a computer system adapted to perform the method, or a computer storage device storing computer-usable instructions that cause a computer system to perform the method.

Example 11 in the second group includes operations for receiving a first image of a first object and a second image of a second object; determining a verification code between the first object and the second object based on a plurality of neural networks for inner-class mismatch detection, and generating an electronic message to indicate the verification code.

Example 12 may include any subject matter of examples in the second group, and further includes operations for producing, via the first neural network, a feature map from a training image; identifying channel-wise spatial relations of the feature map via a bilinear transformation on the feature map; determining respective weights for channels of the feature map based on the channel-wise spatial relations of the feature map; sampling, based on the respective weights for the channels of the feature map, the channels of the feature map to form a plurality of subset feature maps; and training the first neural network to generate an attention map of the training image based on the plurality of subset feature maps.

Example 13 may include any subject matter of examples in the second group, and further includes operations for generating, via the first neural network, a variational attention map of the first image; and producing, via a non-uniform sampler, a detail-attentive image from the first image based on the variational attention map.

Example 14 may include any subject matter of examples in the second group, and further includes operations for extracting, via a second neural network of the plurality of neural networks, a feature vector of the detail-attentive image.

Example 15 may include any subject matter of examples in the second group, and further includes operations for computing a similarity measure between the feature vector of the detail-attentive image and another feature vector of the second image; in response to the similarity measure being above a threshold, generating a positive verification code; and in response to the similarity measure being below the threshold, generating a negative verification code.

Example 16 may include any subject matter of examples in the second group, and further includes operations for transforming, via a third neural network of the plurality of neural networks, the feature vector of the detail-attentive image and another feature vector of the second image to become a first enhanced feature vector and a second enhanced feature vector respectively; computing a similarity measure between the first enhanced feature vector and the second enhanced feature vector; in response to the similarity measure being above a threshold, generating a positive verification code; and in response to the similarity measure being below the threshold, generating a negative verification code.

Examples in the third group comprises a method, a computer system adapted to perform the method, or a computer storage device storing computer-usable instructions that cause a computer system to perform the method.

Example 16 in the third group includes operations to receive a first image of the first object and a second image of the second object; determine the verification code between the first object and the second object with a plurality of progressive stages that include a stage of cross-class mismatch detection and a stage of inner-class mismatch detection; and generate an electronic message to indicate the verification code.

Example 17 may include any subject matter of examples in the third group, and further specify that the stage of inner-class mismatch detection comprises an attention network with an encoder and a decoder to produce a high-resolution feature map.

Example 18 may include any subject matter of examples in the third group, and further specify that wherein the decoder comprises at least one convolutional module with a plurality of branches using different dilation rates.

Example 19 may include any subject matter of examples in the third group, and further includes operations to enlarge receptive fields of the high-resolution feature map via an elementwise summation of outputs of the plurality of branches.

Example 20 may include any subject matter of examples in the third group, and further specify that the stage of inner-class mismatch detection comprises a neural network with at least three fully connected layers.

Example 21 may include any subject matter of examples in the third group, and further includes operations to train the neural network with a loss function to enhance mismatch discriminative power between two input feature vectors with a soft label, wherein the soft label is formed with a first mean being less than 1.0 to represent a positive pair of input feature vectors, and a second mean being greater than 0.0 to represent a negative pair of input feature vectors.

What is claimed is:

1. A computer-implemented method for verification, comprising:
receiving a first image of a first object and a second image of a second object;
determining a verification code between the first object and the second object with a plurality of progressive stages that include a stage of cross-class mismatch detection and a stage of inner-class mismatch detection; and
generating an electronic message to indicate the verification code.

2. The method of claim 1, wherein the first image is captured via a camera operably coupled with a checkout machine, and the second image is selected by a user via a user interface on the checkout machine.

3. The method of claim 1, further comprising:
extracting, via a first neural network, a first feature vector of the first image; and
computing a first similarity measure between the first feature vector and a second feature vector of the second image.

4. The method of claim 3, further comprising:
in response to the first similarity measure being above a first threshold, generating a positive verification code.

5. The method of claim 3, further comprising:
in response to the first similarity measure being below a first threshold, invoking the stage of cross-class mismatch detection.

6. The method of claim 5, further comprising:
transforming, via a second neural network in the stage of cross-class mismatch detection, the first feature vector and the second feature vector to become a first enhanced feature vector and a second enhanced feature vector respectively, wherein the second neural network is trained with a loss function to enhance mismatch discriminative power; and
computing a second similarity measure between the first enhanced feature vector and the second enhanced feature vector.

7. The method of claim 6, further comprising:
in response to the second similarity measure being above a second threshold, generating a positive verification code;
in response to the second similarity measure being below a third threshold, generating a negative verification code; and
in response to the second similarity measure being between the second threshold and the third threshold, invoking the stage of inner-class mismatch detection.

8. The method of claim 1, further comprising:
generating, via a variational trilinear transformation process, a variational attention map from the first image;
producing, via a non-uniform sampler, a detail-attentive image from the first image based on the variational attention map; and
extracting, via a first neural network, a feature vector of the detail-attentive image.

9. The method of claim 8, further comprising:
computing a third similarity measure between the feature vector of the detail-attentive image and another feature vector of the second image;
in response to the third similarity measure being above a fourth threshold, generating a positive verification code; and
in response to the third similarity measure being below the fourth threshold, generating a negative verification code.

10. The method of claim 8, further comprising:
transforming, via a second neural network in the stage of inner-class mismatch detection, the feature vector of the detail-attentive image and another feature vector of the second image to a first enhanced feature vector and a second enhanced feature vector respectively, wherein the second neural network is trained with a loss function to enhance mismatch discriminative power of output of the second neural network;
computing a third similarity measure between the first enhanced feature vector and the second enhanced feature vector;
in response to the third similarity measure being above a fourth threshold, generating a positive verification code; and
in response to the third similarity measure being below the fourth threshold, generating a negative verification code.

11. A computer-readable storage device encoded with instructions that, when executed, cause one or more processors of a computing system to perform operations of verification, comprising:
receiving a first image of a first object and a second image of a second object;
determining a verification code between the first object and the second object based on a plurality of neural networks for inner-class mismatch detection; and
generating an electronic message to indicate the verification code.

12. The computer-readable storage device of claim 11, wherein the instructions that, when executed, further cause the one or more processors to perform operations during a training phase of a first neural network of the plurality of neural networks, comprising:
producing, via the first neural network, a feature map from a training image;
identifying channel-wise spatial relations of the feature map via a bilinear transformation on the feature map;
determining respective weights for channels of the feature map based on the channel-wise spatial relations of the feature map;
sampling, based on the respective weights for the channels of the feature map, the channels of the feature map to form a plurality of subset feature maps; and
training the first neural network to generate an attention map of the training image based on the plurality of subset feature maps.

13. The computer-readable storage device of claim 11, wherein the instructions that, when executed, further cause the one or more processors to perform operations during an inference phrase of a first neural network of the plurality of neural networks, comprising:
generating, via the first neural network, a variational attention map of the first image; and
producing, via a non-uniform sampler, a detail-attentive image from the first image based on the variational attention map.

14. The computer-readable storage device of claim 13, wherein the instructions that, when executed, further cause the one or more processors to perform operations comprising:
extracting, via a second neural network of the plurality of neural networks, a feature vector of the detail-attentive image.

15. The computer-readable storage device of claim 14, wherein the instructions that, when executed, further cause the one or more processors to perform operations comprising:
computing a similarity measure between the feature vector of the detail-attentive image and another feature vector of the second image;
in response to the similarity measure being above a threshold, generating a positive verification code; and
in response to the similarity measure being below the threshold, generating a negative verification code.

16. The computer-readable storage device of claim 14, wherein the instructions that, when executed, further cause the one or more processors to perform operations comprising:
transforming, via a third neural network of the plurality of neural networks, the feature vector of the detail-attentive image and another feature vector of the second image to become a first enhanced feature vector and a second enhanced feature vector respectively;
computing a similarity measure between the first enhanced feature vector and the second enhanced feature vector;
in response to the similarity measure being above a threshold, generating a positive verification code; and
in response to the similarity measure being below the threshold, generating a negative verification code.

17. A system for verification, comprising:
a processor;
a plurality of neural networks, operatively coupled to the processor, configured to determine a verification code between a first object and a second object; and
instructions, wherein the instructions, when executed by the processor, cause the processor to:
receive a first image of the first object and a second image of the second object;
determine the verification code between the first object and the second object with a plurality of progressive stages that include a stage of cross-class mismatch detection and a stage of inner-class mismatch detection; and
generate an electronic message to indicate the verification code.

18. The system of claim 17, wherein the stage of inner-class mismatch detection comprises an attention network with an encoder and a decoder to produce a high-resolution feature map.

19. The system of claim 18, wherein the decoder comprises at least one convolutional module with a plurality of branches using different dilation rates, wherein the instructions, when executed by the processor, further cause the processor to:
enlarge receptive fields of the high-resolution feature map via an elementwise summation of outputs of the plurality of branches.

20. The system of claim 17, wherein the stage of inner-class mismatch detection comprises a neural network with at least three fully connected layers, wherein the instructions, when executed by the processor, further cause the processor to:
train the neural network with a loss function to enhance mismatch discriminative power between two input feature vectors with a soft label, wherein the soft label is formed with a first mean being less than 1.0 to represent a positive pair of input feature vectors, and a second mean being greater than 0.0 to represent a negative pair of input feature vectors.
